(19) United States
(12) Patent Application Publication
(10) Pub. No.: US 2012/0065302 A1
(43) Pub. Date: Mar. 15, 2012

(54) METHOD FOR USING SILANES AND SILANE BLENDS IN WOOD-PLASTIC COMPOSITE MANUFACTURING

(75) Inventors: Kerstin Weissenbach, Hillsborough, NJ (US); Aristidis Ioannidis, Rheinfelden (DE); Doris E. Simoes, Clark, NJ (US)

(73) Assignee: EVONIK DEGUSSA GmbH, Essen (DE)

(21) Appl. No.: 13/061,451

(22) PCT Filed: Jul. 29, 2009
(86) PCT No.: PCT/EP2009/059794

§ 371 Date: Feb. 28, 2011

Related U.S. Application Data
(60) Provisional application No. 61/093,219, filed on Aug. 29, 2008.

(51) Int. Cl. C08L 1/00

(52) U.S. Cl. 524/13

(57) ABSTRACT

A composite of a lignocellulosic material and a plastic is obtained by grafting an organosilane to the plastic, to obtain a grafted plastic; and compounding the grafted plastic with the lignocellulosic material, to obtain the composite.

### BACKGROUND OF THE INVENTION

1. Field of the Invention

The present invention relates to wood-plastic composites (WPCs), in particular WPCs which contain an organic silane or mixtures of organic silanes.

2. Discussion of the Background

The demand for WPCs is growing rapidly due to their wide acceptance in strong and durable outdoor decks and fences, window and door profiles, spas, marina boardwalks, car paneling and truck flooring.

According to a study conducted by Principia Partners in 2003, the North American and Western European demand for WPCs was about 600 million kg, with North America making up 85% of the demand. In North America, 80% of the demand are in the areas of decking, railing, and window and door profiles. The remaining 20% include boardwalks, docks, auto interiors, picnic tables and park benches. The study also projected the growth of WPCs in North America at 14% through 2010.

Some of the advantages of WPCs over solid wood include:
resistance to rotting and insects;
enhanced mechanical properties (flexural and impact strength);
aesthetically appealing with respect to color and surface.

Other advantages of WPCs include (1) wood fiber/flour is a low cost, abundant and renewable material versus conventional reinforcing materials and (2) WPCs can use both recycled resins and wood waste.

Although wood-plastic composites are usually more expensive than solid wood, this difference is shrinking as manufacturers find more efficient ways to produce the composites.

Examples of materials and additives commonly used in WPCs are given below:

| Material | Example |
|---|---|
| resins | polyolefins, mainly HDPE and PP |
| fillers (50-70%) | wood fibers, wood flour |
| additives | heat & light stabilizers |
| | coupling agents |
| | colorants |
| | biocides |
| | foaming agents |

The coupling agents typically used in WPCs have been classified, inter alia, as:
(1) maleated polyolefins,
(2) organosilanes,
(3) chlorinated paraffins (they also act as lubricants), and
(4) zinc stearate, waxes, fatty acid esters (they also act as lubricants and/or dispersing agents).

Maleated polyolefins (PE or PP with maleic anhydride functional groups grafted onto the polymer backbone) are the most widely used “coupling agents” in WPCs.

Currently, wood-plastic composites are commercially also used in industries which do not require extensive strength performance such as in residential applications (i.e. decking, fencing, windows, doors) and in interior automotive applications. However, manufacturers are looking to improve the properties of the wood-plastic composites with the objective of increasing their range of applications. The industry is looking for improvements in properties such as strength, dimensional stability, moisture resistance, scratch resistance, stain resistance, color stability and fire resistance. Commercially, by improving the properties of the wood-plastic composites, they will perform better in their current areas of application as well as increase their scope into more structural type applications such as foundations, bridges, piers, etc.

In order to meet such objective, there have been some studies conducted where vinylsilanes were used for example “Profile Extrusion and Mechanical Properties of Crosslinked Wood-Thermoplastic Composites” article printed in Polymer Composites 2006; “Silane Crosslinked Wood-Thermoplastic Composites” thesis dissertation by Magnus Bengtsson, October 2005, Norwegian University of Science and Technology). In these studies, the compounding of polyethylene and wood flour and VTMO (vinyltrimethoxysilane) grafting were done simultaneously. Results showed improvements in toughness, impact strength, creep performance and water resistance.

In the paper “Profile Extrusion and Mechanical Properties of Crosslinked Wood-Thermoplastic Composites” by Magnus Bengtsson from the Norwegian University of Science and Technology and Nicole Stark from the Forest Products Laboratory, it was investigated if silane crosslinking technology would improve the mechanical properties of the final composite made from high-density polyethylene (HDPE, MFI=33 g/10 min 190° C./2.16 kg), vinyltrimethoxysilane, dicumyl peroxide and pine wood flour (40 mesh). The HDPE (60% w/w), wood flour (40% w/w) and silane (2% w/w) were added to a co-rotating twin screw extruder to produce the composite granulates. In a second step, these composite granulates (96% w/w) were then fed with a lubricant (4% w/w) into the same extruder to produce rectangular profiles. The actual crosslinking step occurred when the rectangular profiles were subjected to moisture at ambient temperature and at 100% R.H. and 90° C. For comparison, a non-crosslinked composite of high density polyethylene and wood flour only was prepared. The mechanical properties were evaluated using flexural testing, drop weight impact testing and creep response. The results of the testing showed an improvement in flexural strength, impact strength and creep response, however no improvement in flexural modulus versus the non-crosslinked wood-plastic composite.

U.S. Pat. No. 7,348,371 describes a wood-plastic composite made from high density polyethylene, a silane-copolymer and cellulosic fiber that showed an improvement in water resistance versus a composite with high density polyethylene and cellulosic fiber only and no silane-copolymer. It should be noted that in this example, the use of the organosilane was not referred to as for “coupling” or “cross-linking”but the organosilane was used as an additive to aid in moisture resistance. The composites were prepared by compounding the following: (1) 50% matrix polymer consisting of various ratios of high density polyethylene (MI=0.3 g/10 min) and a silane-copolymer of ethylene and vinyltrimethoxysilane (MI=1.5 g/10 min) and (2) 50% pine wood flour. It should be noted that the silane-copolymer had to be prepared in an extra step previous to the preparation of the composites. Of interest, in this study, is the comparison between the composites using the HDPE plus the silane-copolymer versus the examples with the HDPE only and no silane-copolymer. The water resistance was evaluated by weighing small samples initially and immersing the samples in water. After certain days, the samples were removed, dried, weighed and percent water absorbed was calculated. The results showed that there was a decrease in water absorption in all the composites with the HDPE plus silane-copolymer versus the composites with HDPE only and no silane co-polymer.

U.S. Pat. No. 6,939,903 describes a process for preparing WPCs using an organosilane (mainly aminosilane) treated natural fiber reacted with a HDPE followed by the addition of a maleic anhydride modified polypropylene. According to U.S. Pat. No. 6,939,903, the mechanical properties of the composite were improved due to the use of a reactive organosilane in conjunction with a functionalized polyolefin coupling agent. A process was described where the composite was prepared by: (1) treating a natural fiber (40 mesh soft wood fiber) with a reactive organosilane (aminopropyltriethoxysilane); (2) mixing the treated natural fiber with polypropylene (MFR=4 g/10 min 230° C./2.16 Kg); and (3) adding a functionalized polyolefin coupling agent (maleic anhydride functionalized polypropylene) to the mixture of the treated natural fiber and the polypropylene resin. The wood-plastic composite was produced by: (1) treating the wood fiber with the aminosilane; (2) drying the wood fiber; (3) treated fiber was then blended with the polypropylene and the maleated polypropylene; (4) this blend was then fed into a twin screw extruder to produce a strand; (5) the strand was cooled in a water bath and palletized; (6) the pellets were dried overnight at 100° C.; and (7) injection molded. The mechanical properties were measured using tensile testing (ASTM D638), flexural testing (ASTM D790) and impact testing (ASTM D256).

WO 2007/107551 discloses that the mechanical properties of the composites were improved when the wood fibers were treated with aqueous organopolysiloxanes containing aminoalkyloxysiloxanes, in particular Dynasylan® Hydrosil 2909. The object of using the aqueous siloxanes is to be able to use these without the VOC emissions normally seen with the hydrolysis of silanes. The work involved first treating the wood with the Hydrosil 2909 at various concentrations. Composites of 60% treated wood and 40% polypropylene were prepared via extrusion. The mechanical properties and water absorption were evaluated.

### SUMMARY OF THE INVENTION

It was an object of the present invention to apply silane cross-linking and coupling technology to wood-plastic composites.

It was another object of the present invention to (1) improve the adhesion between a resin, such as polyethylene, and the filler such as wood flour, (2) improve the overall mechanical properties of the finished composite and (3) improve the moisture resistance of the finished composite.

It was a further object of the present invention to compare traditional coupling agents, such as maleated polyolefins with vinylsilanes in WPCs with respect to mechanical and performance tests, such as toughness, impact strength, creep performance and water resistance.

It was yet another object of the present invention to test if aminosilanes could be used in conjunction with maleated polyolefins for enhanced adhesion in WPCs. For example, Dynasylan® AMEO, Dynasylan® 1189 and Dynasylan® 1204 has been used to couple maleated PP and MDH in cable applications. It was an object to compare maleated PP and maleated PP plus aminosilane to determine any improvements using the above performance and mechanical tests.

This and other objects have been achieved by the present invention the first embodiment of which includes a method of producing a composite of a lignocellulosic material and a plastic, comprising:

grafting an organosilane to said plastic, to obtain a grafted plastic; and
compounding said grafted plastic with said lignocellulosic material, to obtain said composite.

In another embodiment, the present invention relates to a composite prepared by the above method.

### BRIEF DESCRIPTION OF DRAWINGS

FIG. 1 shows the flexural strength of samples according to the present invention and comparative samples.

FIG. 2 shows the flexural modulus of samples according to the present invention and comparative samples.

FIG. 3 shows the tensile strength of samples according to the present invention and comparative samples.

FIG. 4 shows the tensile modulus of samples according to the present invention and comparative samples.

FIG. 5 shows the Izod impact strength of samples according to the present invention and comparative samples.

FIG. 6 shows the coefficient of thermal expansion of samples according to the present invention and comparative samples.

FIG. 7 shows a schematic of gel content test.

FIG. 8 shows the change in various properties of samples according to the present invention and comparative samples.

FIG. 9 shows the change in various properties of samples according to the present invention and comparative samples.

FIG. 10 shows the flexural strength of samples according to the present invention and comparative samples.

FIG. 11 shows the flexural modulus of samples according to the present invention and comparative samples.

FIG. 12 shows the tensile strength of samples according to the present invention and comparative samples.

FIG. 13 shows the tensile modulus of samples according to the present invention and comparative samples.

FIG. 14 shows the Izod impact strength of samples according to the present invention and comparative samples.

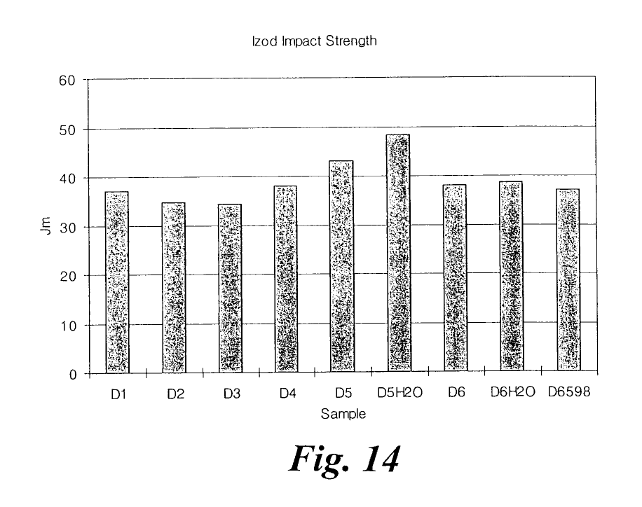

FIG. 15 shows the coefficient of thermal expansion of samples according to the present invention and comparative samples.

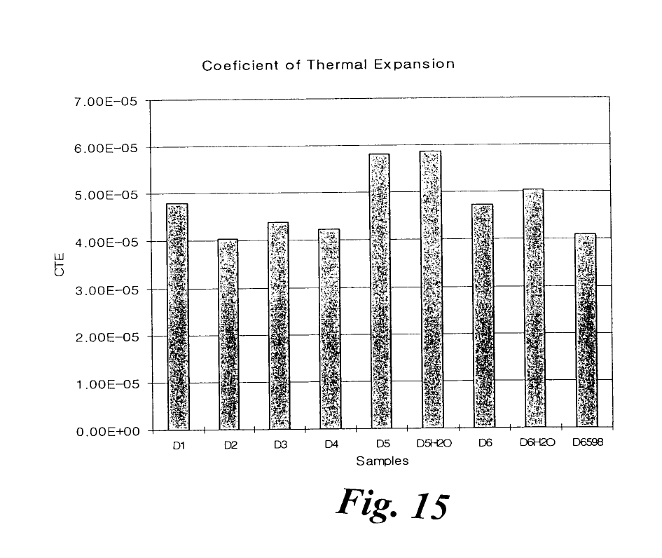

### DETAILED DESCRIPTION OF THE INVENTION

The inventor of the present invention has found that the present invention brings the following benefits versus the current industry technology which is maleated-polyolefin coupling agents: (1) an increase in flexural, tensile and impact properties and (2) an increase in moisture resistance. More importantly, it has been demonstrated that these enhanced properties were obtained using a single step process in the manufacturing of the wood-plastic composite.

The wood-plastic composite comprises (1) a plastic, preferably a thermoplastic resin, (2) a filler such as a lignocellulosic material, for example in the form of particles, chips and/or fibers, preferred are for example wood fiber, wood turnings, wood chips and/or wood flour and (3) additives. The thermoplastic resin and the lignocellulosic material may be obtained through recycling.

The plastic is not particularly limited. Thermoplastic resin are preferred. Preferred thermoplastic resins include polyolefins such as polyethylene, preferably HDPE, polypropylene, preferably isotactic polypropylene; polyvinyl chloride, polystyrene, acrylonitrile-butadiene-styrene and/or melamine resin. The thermoplastic resin may be functionalized with functional groups or may not contain any functional groups. Functional groups are, for example hydroxyl groups or carboxyl groups. The thermoplastic resin can be a homopolymer, copolymer, or block copolymer. One or more types of thermoplastic resin may be used as a mixture.

The filler is preferably a lignocellulosic material. The shape of the filler is not particularly limited as long as it can be combined with the thermoplastic resin. Examples are particles, chips, strips and/or fibers. The lignocellulosic material is preferably wood, more preferably in the form of wood fiber, wood turnings, wood chips and/or wood flour. Any wood or combinations of wood can be used.

The amount of filler is in the order of 10 to 95% by weight based on the weight of the composite, including all subvalues, preferably 30-95% by weight, more preferably 40-95% by weight, even more preferably 50-70% by weight. The moisture content of the filler can be 0.1 to 10% by weight, based on the weight of the filler.

The wood floor is not particularly limited. However, a wood floor having a fine particles size in the order of 10 to 100 mesh, including all subvalues, preferably 20-60 mesh, from any wood, preferably from oak, pine or maple wood can be used. One or more types wood floor can be used.

Further, wood fibers, wood chips, wood turnings and wood particles from any wood can be used, alone or in combination. In addition, other lignocellulosic materials may be used instead of or in a blend with the wood flour, fibers and/or particles or other forms of wood.

The additive is not particularly limited and is chosen depending on the intended application. Preferred additives include lubricants, coupling agents, stabilizers such as heat & light stabilizers, biocides, colorants, biocides and foaming agents. One or more additives can be used. One or more types of a particular additive can be used. For example, one or more lubricants can be used.

WPCs are preferably manufactured by extrusion, compression molding or injection molding. However, the method of manufacturing is not particularly limited. Any forming method may be applied. Wood-plastic composites are widely used in applications such as decking, fencing, windows, doors, automotive and furniture.

In order to make the composites more durable and stronger the following are of interest: (1) improving their properties in current areas of application, and (2) increasing their strength to broaden their application into structural areas such as foundations, bridges and piers. With regard to durability, the industry requirements are, for example, moisture resistance, scratch resistance, stain resistance, color stability and fire resistance. With regard to strength, improvements in mechanical properties such as tensile strength, flexural strength, impact strength and creep resistance are of interest.

One way to address some of these industry requirements is to investigate and improve the interfacial bond between the hydrophilic wood flour and the hydrophobic thermoplastic resin. This adhesion at the interface between the wood flour and the resin is accomplished by the use of coupling agents. Currently, the coupling agents used in wood-plastic composites include maleated polyolefins (i.e maleic anhydride grafted polyethylene or polypropylene) and organosilanes. Of particular interest to the present invention is the use of organosilanes, including for example vinylsilanes and vinyl oligomeric silanes.

In general, organosilanes are molecules which have a dual functionality where one side is hydrophilic and the other side is hydrophobic.

In one embodiment, there are three alkoxy groups on the hydrophilic side of the organosilane, which, in the presence of moisture, become hydrolyzed into three hydroxyl groups. These groups will then bond and condense with hydroxyl groups on the hydrophilic wood flour.

In one embodiment, there is an organofunctional group on the hydrophobic side of the organosilane. While the organofunctional group is not particularly limited, it preferably is compatible with the resin used in the composite.

The organosilanes include vinylsilanes, vinyl oligomers, other silanes and mixtures thereof. They can be used as coupling agents or crosslinkers for the composites of the present invention.

In addition, aminosilanes can be used, for example in combination with maleic anhydride grafted PE or maleic anhydride grafted PP for the composites of the present invention.

Further, silanes such as vinyl oligomers, vinylsilanes, alkylsilanes, alkyl oligomers, fluoro silanes and polyglycol functional silanes can be used as hydrophobizing, oleophobizing, and dispersing agents for the WPCs of the present invention.

Preferred vinylsilanes are vinyltrimethoxysilane, vinyltriethoxysilane, vinyltrimethoxyethoxysilane, vinyltripropoxysilane.

Examples for so called vinyl oligomers, especially vinylsilane oligomers and vinyl-/alkylsilane cooligomers, are shown in U.S. Pat. No. 5,282,998, especially vinylmethoxysilane oligomers, vinylethoxysilane oligomers, vinyl-/n-propylmethoxysilane cooligomers, vinyl-/propylethoxysilane cooligomers, vinyl-/butylmethoxysilane cooligomers, vinyl-/octylmethoxysilane cooligomers, vinyl-/butylethoxysilane cooligomers, vinyl-/octylethoxysilane cooligomers.

Other preferred organosilanes (silanes) are aminosilanes, especially aminoalkyl-trialkyoxysilanes, e.g. aminopropyltrimethoxysilane, aminopropyltriethoxysilane, aminoethylaminopropyltrimethoxysilane, aminoethylaminoethylaminopropyltrimethoxysilane, (RO)₃Si(CH₂)₃NH(CH₂)₃Si(OR)₃, N-alkylated aminosilanes, especially N-butylaminopropyltrimethoxysilane, and physical blends thereof, alkylsilanes, R¹Si(OR′)₃ with R¹=linear, cyclic or branched alkyl rest with 1-20 C-atoms, e.g. n-propyltrimethoxysi lane (PTMO), n-propyltriethoxysilane (PTEO), i-butyltrimethoxysilane (IBTMO), i-butyltriethoxysilane (IBTEO), octyltrimethoxysilane (OCTMO), octyltriethoxysilane (OCTEO), 3-chloropropyltrimethoxysilane (CPTMO), 3-chloropropyltriethoxysilane (CPTEO), alkylsilane oligomers, more specific linear, cyclic and three dimensional oligomers of condensed R¹Si(OR′)₃ with R¹=linear, cyclic or branched alkyl rest with 1-20 C-atoms, e.g. U.S. Pat. No. 5,932,757, U.S. Pat. No. 6,133,466, U.S. Pat. No. 6,395,858, U.S. Pat. No. 6,767,982, U.S. Pat. No. 6,841,197, fluorosilanes, more exact fluoroalkylsilane, especially CF₃(CF₂)ₙ(CH₂)ₘSi(OR″)₃ with n=5, m=3, and R″=Et, polyglycol functional silane, more specific polyglycolalkylsilane, e.g. MeO-(CH₂—CH₂—O)ₙ—Si(OR″)₃ with n=1-20 and R″ is Me, and mixtures thereof.

While not particularly limited, preferably, there are two mechanisms by which the organofunctional group of the silane will react with the resin.

One mechanism, called coupling, occurs when the silane forms a “bridge” between the wood flour and the thermoplastic resin.

The other mechanism, called crosslinking, involves two steps. The first step, called grafting, takes place when the organosilane, for example a vinylsilane, initiated by a small amount of a catalyst such as peroxide, “grafts” itself onto a polymer backbone, for example a polyethylene backbone. The second step, called crosslinking, occurs when the grafted organosilane groups on the various polyethylene chains, hydrolyze and condense in the presence of moisture forming links between the polyethylene chains.

The treatment time for the lignocellulosic material with the organosilane is 1 min. to 10 hours, including all subvalues, preferably 1 to 2 hours. The reaction temperature can be 40 to 80° C., including all subvalues. In one embodiment, the organosilane is contained in an aqueous system such as an emulsion or solution. In one embodiment, no organic solvent is used. If necessary, the pH can be adjusted between 1 and 8, including all subvalues.

Organosilanes from the Dynasylan® SIVO family of compounds can be used for cross-linking. Other Dynasylan® products can be used for coupling between the lignocellulosic material and the polymer, and in the pre-treatment of lignocellulosic material such as wood flour (for example Dynasylan® 6598).

Further organosilanes, organosilane compounds and/or organosilane compositions used in a preferred embodiment of the present invention are the following:

| Dynasylan ® | | |
|---|---|---|
| Family | Chemicals & Functions | Dose |
| 6598 | Vinyl-/alkylsilane cooligomer (ethoxy functional) | 1% |
| | Dynasylan ® 6598 is excellent as an adhesion promoter in mineral-filled, peroxide-crosslinked compounds. The | |
| | silicon-functional ethoxy groups of Dynasylan ® 6598 hydrolyse in the presence of moisture, which is usually | |
| | present on the filler surface, forming active silanol groups. The condensation of these silanol groups with | |
| | hydroxyl groups on the filler surface leads to a tight chemical bond between Dynasylan ® 6598 and the filler. | |
| | The vinyl functional end of Dynasylan ® 6598 can be coupled to the polymer in a further reaction that runs | |
| | parallel to peroxide crosslinking. | |
| | The propyl groups of Dynasylan ® 6598 are hydrophobic and result in markedly improved electrical properties | |
| | of the filled compounds, especially after exposure to water. A major field of application for mineral-filled | |
| | compounds is the cable industry. EPDM filled with kaolin can be processed into cable compounds through the | |
| | adhesion promoting and hydrophobic effects of Dynasylan ® 6598. It can also be used in the manufacture of | |
| | halogen-free, non-toxic, environmentally-friendly flame retardant compounds (HFFR) based on EVA or PE and | |
| | ATH or MDH. In addition, Dynasylan ® 6598 can be used in many other applications such as filler and pigment | |
| | treatment, use in dispersions etc. | |
| 1189 | N-(n-Butyl)-3-aminopropyltrimethoxysilane | 1% |
| | Dynasylan ® 1189 has many important applications. Examples include: | |
| | as a size constituent or finish for glass fiber/glass fabric composites | |
| | as an additive to phenolic, furan and melamine resins used in foundry resins | |
| | as a primer or additive and for the chemical modification of sealants and adhesives | |
| | for pretreatment of fillers and pigments used in mineral-filled polymers | |
| | as a primer and additive for improving the adhesion of paints and coatings to the substrate. | |
| | The most important product effects that can be achieved using Dynasylan ® 1189 include: | |
| | flexural strength, tensile strength, impact strength and modulus of elasticity | |
| | improved moisture and corrosion resistance | |
| CPTEO | 3-chloropropyltriethoxysilane | 1% |
| SIVO 505 | Vinylttrimethoxysilane/di-tert-butyl 1,1,4,4-tetramethyltetramethylene diperoxide | 0.8% |
| | The product is a cross-linking agent. | |

In one embodiment, a vinylsilane is combined with a peroxide and a catalyst for the grafting step to the polymer.

The amount of organosilane for the grafting step can be in the order of 0.1 to 10% by weight based on the weight of the polymer. This range includes all subvalues including 0.5, 0.7, 0.9, 1, 1.5, 2, 2.5, 3, 3.5, 4, 4.5, 5, 5.5, 6, 6.5, 7, 7.5, 8, 8.5, 9 and 9.5% by weight.

In one embodiment, a vinylsilane oligomer is used to pretreat the lignocellulosic material.

In another embodiment, an organosilane is used for the coupling between the lignocellulosic material (for example wood flour) and the polymer (for example PE). The amount of organosilane for the pretreatment step or the coupling step can be in the order of 0.1 to 10% by weight based on the weight of the lignocellulosic material. This range includes all subvalues including 0.5, 0.7, 0.9, 1, 1.5, 2, 2.5, 3, 3.5, 4, 4.5, 5, 5.5, 6, 6.5, 7, 7.5, 8, 8.5, 9 and 9.5% by weight.

The wood-plastic composites according to the present invention can be prepared by mechanical compounding. In a preferred embodiment, the wood-plastic composites according to the present invention can be prepared by reactive extrusion of a polymer with either untreated wood flour or wood flour pre-treated with an organosilane, for example a vinylsilane. Instead of wood flour, any wood particles for example wood fibers or wood chips may be used, each untreated or pretreated. Moreover, any other lignocellulosic material as defined above may be used. The polymer can be first grafted with the organosilane. The grafting step can be performed, for example in an extruder, such as a single screw extruder or twin screw extruder. The amount of organosilane can be in the order of 0.1 to 10% by weight based on the weight of the polymer. This range includes all subvalues including 0.5, 0.7, 0.9, 1, 1.5, 2, 2.5, 3, 3.5, 4, 4.5, 5, 5.5, 6, 6.5, 7, 7.5, 8, 8.5, 9 and 9.5% by weight.

The grafted polymer is then compounded with the lignocellulosic material, for example, either in the same extruder or in a second extruder. The process may be continuous or batchwise. The product may have any shape or size without particular limitation. In one embodiment boards can be produced.

In order to accomplish the crosslinking step, the product, for example boards are exposed to a water containing environment, for example in a water cooling spray tank or in a humidity chamber. A relative humidity of at least 80%, preferably at least 90%, more preferably at least 95% is maintained. A temperature of at least 40° C., more preferably at least 50° C., even more preferably at least 60 or at least 70° C. and most preferably at least 80° C. is maintained. After the crosslinking, the final product can be dried, if necessary, at temperatures between room temperature and a temperature below the melting point of the resin, including all subvalues.

The pre-treatment of the wood flour with an organosilane is accomplished as follows. The wood flour may be used as is or in pre-dried form. Preferably, the wood flour has a moisture content of 0.1 to 2% by weight, (including subvalues) based on the weight of the wood flour. The dry wood flour is then contacted with 0.1 to 10% by weight of silane, based on the weight of the wood flour. For example, the silane can be atomized unto the wood flour for a predetermined period of time. The silane treated wood flour is then cured at elevated temperatures, for example 80-120° C. for 1-48 hours, each including subvalues.

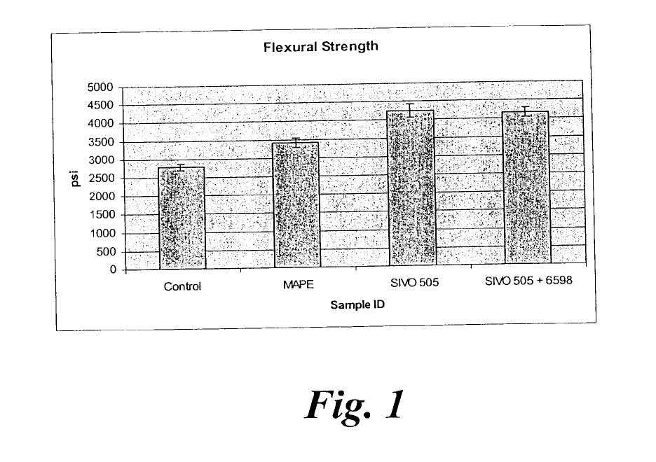

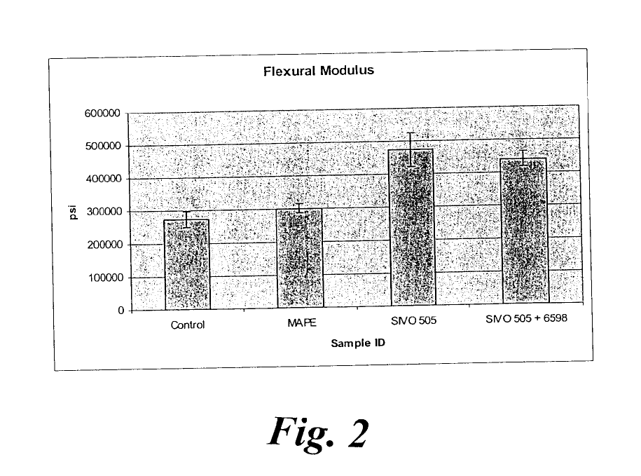

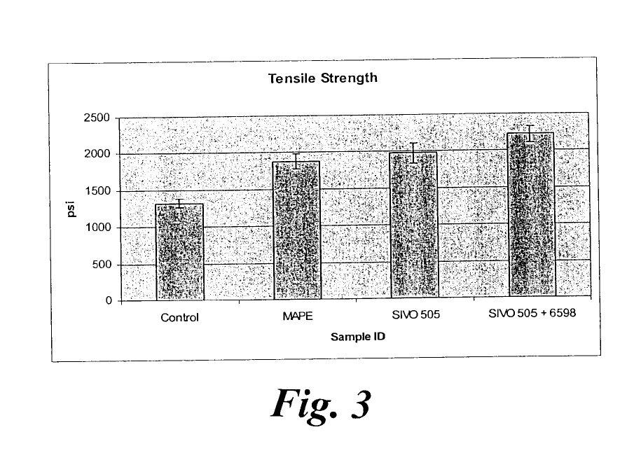

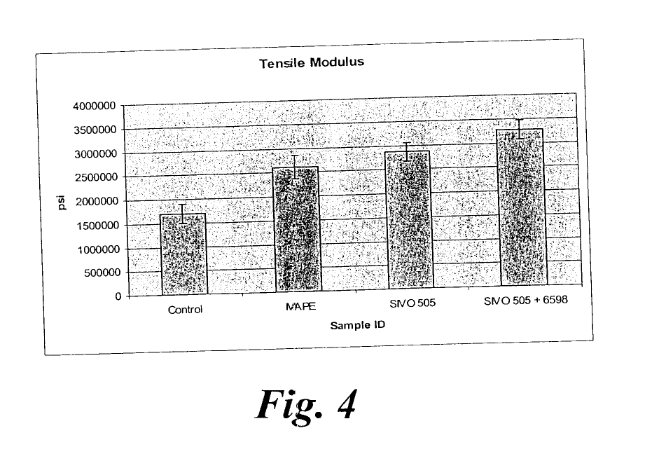

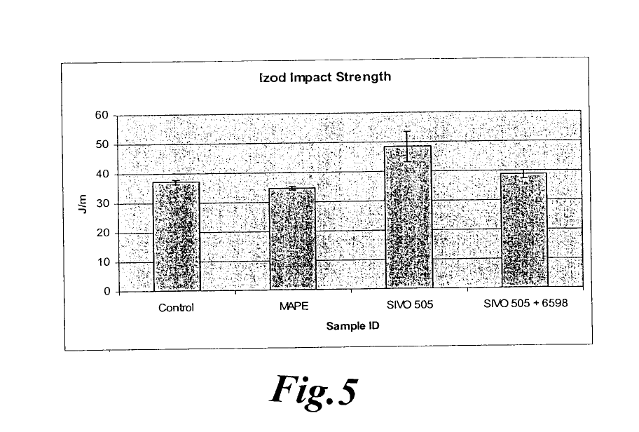

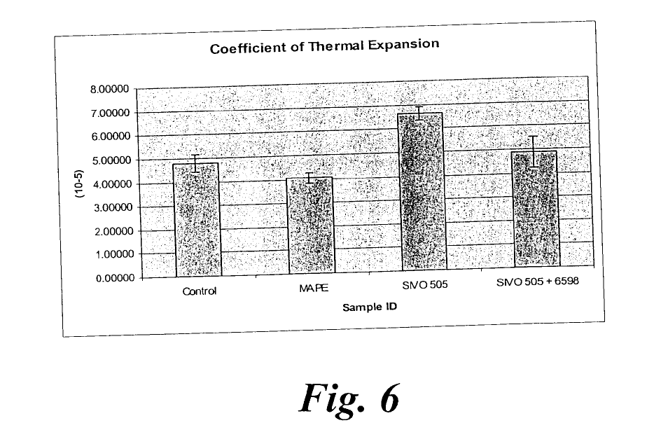

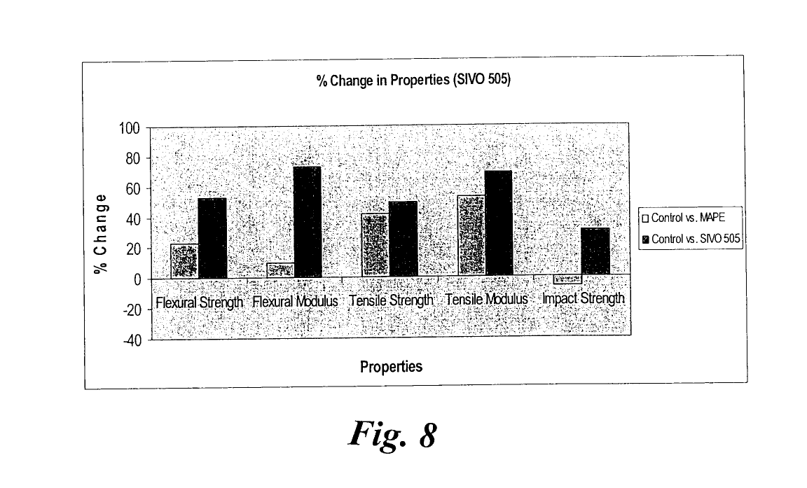

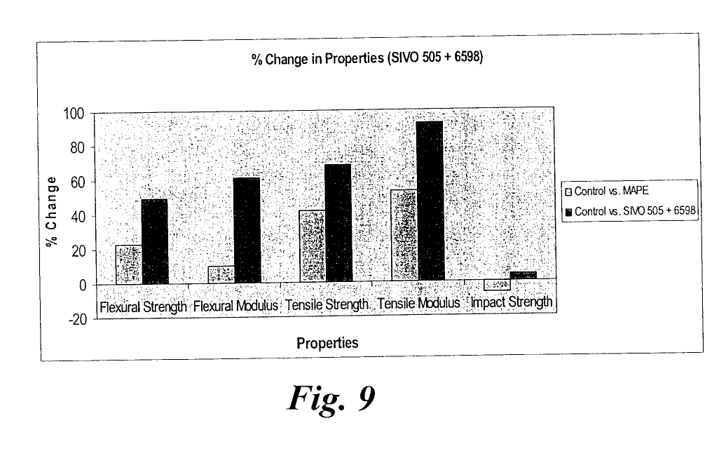

In one embodiment, HDPE, wood flour and a lubricant are used. An organosilane of the Dynasylan® group of silane compounds is used as a coupling agent between the wood flour and the HDPE. In addition, an organosilane of the Dynasylan® SIVO group is used for grafting onto the wood flour. Compounding was done by a combination of a single screw extruder followed by a twin screw extruder to produce the composite boards. The boards were moisture cured at 90% relative humidity (RH) and 80° C. A comparison was made between a) a control (HDPE and wood flour only) and b) the industry standard (HDPE, wood flour and MAPE-maleated polyethylene), c) a sample of HDPE, wood flour and Dynasylan® SIVO 505 [as an example for a physical blend of at least one vinylsilane, especially vinyltrimethoxysilan, vinyltriethoxysilane, and/or vinyltrimethoxyethoxysilane, with at least one peroxide, preferred organic peroxides as radicalformers and/or organic peresters or blends thereof, as preferred tert.-butylperoxypivalate, tert.-butylperoxy-2-ethyl hexanoate, dicumylperoxide, di-tert.-butylperoxide, tert.-butylcumylperoxide, 1,3-di(2-tert.-butylperoxyisopropyl)benzene, 2,5-dimethyl-2,5-bis(tert.-butylperoxy)hexyne(3), di-tert.-amylperoxide, 1,3,5-tris(2-tert.-butylperoxyisopropyl)benzene, 1-phenyl-1-tert.-butylperoxyphthalide, alpha,alpha′-bis(tert.-butylperoxy)-diisopropylbenzene, 2,5-dimethyl-2,5-di-tert-butylperoxyhexane 1,1-di(tert.-butylperoxy)-3,3,5-trimethylcyclo-hexane (TMCH), n-butyl-4,4-di(tert.-butylperoxy)valerate, ethyl-3,3-di(tert.-butylperoxy)butyrate and/or 3,3,6,9,9-hexamethyl-1,2,4,5-tetraoxa-cyclononane, and optionally a catalyst, e.g. dibutyltindilaurate, dioctyltinlaurate], and d) a sample of HDPE, wood flour and Dynasylan® SIVO 505 and Dynasylan® 6598. Their properties were evaluated according to the following standards: Flexural Testing (ASTM D6109), Tensile Testing (ASTM D638), Izod Impact Strength (ASTM D256), Coefficient of Thermal Expansion (ASTM D696), Gel Content (ASTM D2765) which are further described in the Examples. The results and are shown in FIGS. 1-6. Both, the Dynasylan® SIVO 505 and the Dynasylan® SIVO 505+Dynasylan® 6598 showed an increase in flexural strength and an increase in flexural modulus versus the control and the industry standard. Dynasylan® SIVO 505+Dynasylan® 6598 showed an increase in tensile strength and an increase in tensile modulus versus the control and the industry standard and Dynasylan® SIVO 505. Dynasylan® SIVO 505 showed an increase in impact strength and an increase in CTE versus the control and industry standard. Overall, Dynasylan® SIVO 505 performed the best. See also FIGS. 8 and 9.

The composites of the present invention can be used for various applications as discussed above and including, but not limited to outdoor decks and fences, window and door profiles, spas, marina boardwalks, car paneling and truck flooring.

Having generally described this invention, a further understanding can be obtained by reference to certain specific examples which are provided herein for purposes of illustration only, and are not intended to be limiting unless otherwise specified.

### EXAMPLES

With regard to the present invention, a study was designed to evaluate vinylsilane crosslinking and coupling technology in wood-plastic composites, mainly composites of wood flour and high density polyethylene. The objectives of the work were to (1) improve the interfacial adhesion between the wood flour and the polyethylene and, in doing so, improve the mechanical properties of the composite and (2) improve the moisture resistance of the composite.

### Example 1

In this study, wood-plastic composites were prepared by reactive extrusion using high density polyethylene with either untreated wood flour or wood flour pre-treated with Dynasylan® 6598. The process began with the grafting of the high density polyethylene with Dynasylan® SIVO 505 in a single screw extruder. The grafted-HDPE was then fed directly into the twin screw extruder where it was compounded with the wood flour in a continuous process to produce the sample boards. In order to accomplish the crosslinking step, the sample boards after exiting the die, were either sent through a water cooling spray tank or were placed in a humidity chamber at 90% R.H. (relative humidity) and 80° C. For comparison, boards were prepared using the same high density polyethylene and untreated wood flour with no coupling agent designated as the “control”. For further comparison, boards were prepared using the same high density polyethylene and untreated wood flour with the maleic anhydride-grafted polyethylene (MAPE) coupling agent designated as the “industry standard”. The sample boards were then subjected to evaluation of the mechanical properties. The results showed a 60% increase in strength (modulus of rupture) and a 70% increase in stiffness (modulus of elasticity) versus the control and the industry standard.

### Materials

The formulations contained the high density polyethylene, wood flour, lubricant and silane. Please see Table 1 below for specifications of materials used.

TABLE 1

| Material | Trade Name | Notes |
|---|---|---|
| HDPE | A4040 | LyondeIIBasseII Polyolefins |
| | | MFI = 3.5 g/10 min 190° C./2.16 kg |
| Wood flour | Pine wood flour | American Wood Fiber, Inc. |
| | | 40 mesh |
| Crosslinking | Dynasylan ® SIVO | Proprietary blend of VTMO |
| agent | 505 | (25-100%) + di-tert-butyl-1,1,4,4- |
| | | tetramethyltetramethylene di-peroxide |
| | | (1-20%) + tin catalyst 0.8% |
| | | dosage based on HDPE |
| Coupling | Dynasylan ® 6598 | Vinyl-/alkylsilane oligomer |
| agent | | 1% dosage based on wood flour |
| Lubricant | Struktol 113 | Struktol |
| | | 5% based on total weight |

### Sample Formulations

The above materials were used to prepare the formulations shown in Table 2 below. The composites were processed by reactive extrusion using a Davis-Standard® WT-94 Woodtruder™. This extruder system consisted of a GP94 94 mm counter-rotating parallel twin-screw extruder (28:1 L/D) which was coupled with a Mark V™ 75 mm single crew extruder. The output rate of extrusion was set to 200 lbs/hr. During the processing of samples 5, 5H₂O, 6 and 6H₂O, the Dynasylan® SIVO 505 was injected at a constant rate into the polymer feeder (on the single screw extruder) via a pump. The silane blend was added at 0.8% by weight based on the HDPE.

TABLE 2

| Sample | | Wood | | |
|---|---|---|---|---|
| ID | HDPE | flour | Lubricant | Notes |
| 1 | 45% | 50% | 5% | Control |
| 2 | 45% | 50% | 5% | Industry standard |
| | | | | 2% MAPE |
| 5 | 45% | 50% | 5% | Non-treated wood flour |
| | | | | 0.8% Dynasylan ® SIVO 505 |
| 5 H₂O | 45% | 50% | 5% | Non-treated wood flour |
| | | | | 0.8% Dynasylan ® SIVO 505 |
| | | | | H₂O means moisture cured |
| | | | | at 90% RH and 80° C. |
| 6 | 45% | 50% | 5% | Wood flour pre-treated |
| | | | | with 1% b.w. |
| | | | | Dynasylan ® 6598 |
| | | | | 0.8% Dynasylan ® SIVO 505 |
| 6 H₂O | 45% | 50% | 5% | Wood flour pre-treated |
| | | | | with 1% b.w. |
| | | | | Dynasylan ® 6598 |
| | | | | 0.8% Dynasylan ® SIVO 505 |
| | | | | H₂O means moisture cured at |
| | | | | 90% RH and 80° C. |

The pre-treatment of the wood flour with the Dynasylan® 6598, as in samples 6 and 6H₂O above, was accomplished as follows. The wood flour was pre-dried for 96+ hours in a kiln (<2% R.H., 150° F. dry bulb, 80° F. wet bulb). After drying, the moisture content of the wood flour was between 1.3-1.5% by weight. In order to lower the moisture content further (<1%), the wood flour was further dried in an oven at 105° C. for at least 24 hours. The dried wood was placed in a blender rotating at 15 rpm. 1% by weight silane, based on wood flour loading, was atomized unto the wood flour over a period of 10-15 minutes. The silane treated wood flour was then cured in an oven at 105° C. for 24 hours.

### Testing of the Physical and Mechanical Properties

The sample wood-plastic composite boards were subjected to the following tests:
Flexural Bending per ASTM D 6109
Tensile Strength per ASTM D 638
Impact Resistance per ASTM D 256
Thermal Expansion per ASTM D 696
Gel Content per ASTM D 2765

### Material Property Testing

TABLE 3

| | | | # of samples | |
|---|---|---|---|---|
| | | | (# of | |
| | Test Item | Standards | specimens) | Note |
| 1 | Gel content test | ASTM D2765 | 4 (12) | Duplicates = 3 |
| 2 | Flexural test | ASTM D790 | 8 (40) | Duplicates = 5 |
| 3 | Tensile test | ASTM D638 | 8 (40) | Duplicates = 5 |
| 4 | Izod impact | ASTM D256 | 8 (40) | Duplicates = 5 |
| | test | | | |
| 5 | CTE test | ASTM D696 | 8 (40) | Duplicates = 10 |
| 6 | Water | ASTM D570 | 8 (40) | Duplicates = 5 |
| | absorption test | | | |

### Extrusion Processing

The extrusion processing took place on a Davis-Standard WT-94 Woodtruder™ system. This system consists of a 75 mm Mark V single screw extruder (L/D 24:1) that introduces the polymer in a melt state into a 94 mm counter-rotating parallel twin-screw extruder (L/D 28:1). Both extruder systems utilize gravimetric feeders to accurately deliver multiple formulation components. In the experimentation, the wood loading level was 50% wt. Lubricant was added at 5% wt.

### Moisture Curing

Standard test for mechanical testing were cut from the extrusion profile. Part of the samples were stored at room temperature and the others were stored in a conditioned chamber for different conditions. The conditioned specimens were subsequently dried to their initial weight before testing.

### Gel Content Test

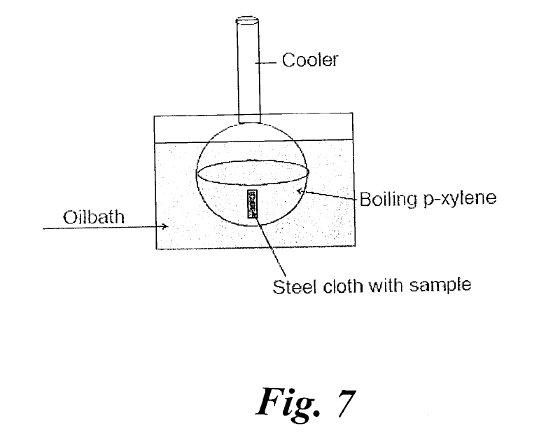

The gel content of the samples were determined using p-xylene extraction, according to ASTM D2765. FIG. 7 shows a schematic of gel content test.

The results were the following:

TABLE 4

| Test | 1 | 2 | 5 | 5H₂O | 6 | 6H₂O |
|---|---|---|---|---|---|---|
| Flexural Strength | 2782 | 3806 | 4256 | 4245 | 4290 | 4160 |
| (lbs/in²) | | | | | | |
| Flexural Modulus | 273174 | 328996 | 466342 | 471995 | 433825 | 440091 |
| (lbs/in²) | | | | | | |
| Tensile Strength | 1321 | 1876 | 2116 | 1974 | 2029 | 2223 |
| (lbs/in²) | | | | | | |
| Tensile Modulus | 1698646 | 2602135 | 2709354 | 2867774 | 2723088 | 3266348 |
| (lbs/in²) | | | | | | |
| Impact Strength | 37.04 | 34.71 | 43.06 | 48.36 | 38.14 | 38.64 |
| (J/m) | | | | | | |
| CTE (10⁻⁵) | 4.798 | 4.050 | 5.821 | 5.865 | 4.735 | 5.041 |
| Gel Content (%) | — | — | 20.51 | 46.75 | 14.57 | 30.22 |
| Water Absorption | 3.21% | 2.48% | 2.06% | 2.18% | 2.21% | 2.11% |
| (24 hrs) | | | | | | |

The graphs in FIGS. 8 and 9 show the % change in the mechanical properties tested. The first graph compares the control (PE and wood flour only) and the industry standard (PE and wood flour and MAPE) versus the control and the sample labeled 5H₂O (Dynasylan® SIVO 505). The second graph compares the again the control and the industry standard versus the control and the sample labeled 6H₂O (Dynasylan®SIVO 505+Dynasylan® 6598). As shown in the graphs, an improvement was seen in the tensile, mechanical and impact properties of these composites.

The following table shows the differences between embodiments of the present invention and the background art mentioned above.

TABLE 5

| | | | Crompton | Equistar | WO2007/ |
|---|---|---|---|---|---|
| | Present Invention | Bengtsson & Stark | U.S. Pat. No. 6,939,903 | U.S. Pat. No. 7,348,371 | 107551 |
| Silane | Used VTMO blend | Only used VTMO + | Used amino-silane | Used a vinylsilane | Used aqueous |
| | (VTMO + peroxide + | peroxide | (AMEO) to pre- | (VTMO) to make | aminoalkyloxy- |
| | catalyst) used | No catalyst | treat the wood | silane-copolymer | silanes (HYDROSIL |
| | for crosslinking | Used no MAPE or | fiber | Used MAPE as | 2909) as the |
| | agent | MAPP | Used MAPP as | the coupling agent | coupling agent |
| | Used vinyl | | the coupling agent | | |
| | oligomers to pre- | | | | |
| | treat the wood | | | | |
| | flour as coupling | | | | |
| | agent | | | | |
| | Used MAPE for | | | | |
| | comparison | | | | |
| | purposes only | | | | |
| Processing | PE + VTMO blend | Blended PE + | Pre-treated the | Blended the PE + | Pre-treated the |
| | was processed | VTMO + peroxide | wood flour with | silane-copolymer + | wood with silane |
| | first | in one step to | silane | wood flour in one | Compounded the |
| | Followed by | produce | Blended the pre- | step | treated wood with |
| | addition of | granulates | treated wood fiber + | Haake counter- | polypropylene |
| | untreated and pre- | Blended granulates | PP + MAPP in | rotating conical | Extrusion process |
| | treated wood flour | in a second | one step | twin screw | |
| | and lubricant | step with the | Coperion twin | extruder | |
| | Done in a | lubricant | screw extruder | | |
| | simultaneous | Moisture cure | | | |
| | continuous single | done by humidity | | | |
| | step process | chamber at | | | |
| | Moisture cure | ambient and | | | |
| | done by a cooling | 100% RH & 90° C. | | | |
| | water spray | Used Davis | | | |
| | followed by | Standard co- | | | |
| | humidity chamber | rotating twin screw | | | |
| | at 90% RH & 80° C. | extruder | | | |
| | Used Davis | | | | |
| | Standard | | | | |
| | Woodtruder | | | | |
| Ratio of | 50%:50% | 60%:40% | 50%:50% | 50%:50% | 40%:60% |
| % PE:% | | | | | |
| Wood | | | | | |
| (approx.) | | | | | |
| Evaluation | Improved tensile, | Improved creep, | Improved tensile, | Improved water | Improved impact |
| of | flexural and impact | impact and flexural | flexural and impact | resistance | and tensile strength |
| Properties | properties | strength | properties | | Reduced water |
| | Reduced water | No improvement in | | | absorption |
| | absorption | flexural modulus | | | |

### Example 2

Silane compounds, vinyl-/alkylsilane oligomer (Dynasylan® 6598), N-(n-Butyl)-3-aminopropyltrimethoxysilane (Dynasylan® 1189), and 3-chloropropyltriethoxysilane (Dynasylan® CPTEO), were used as treatments to wood fibers for improvements of interfacial properties of the treated wood and polyethylene (PE) in wood plastic composites. Silane compounds create a chemical bridge between the wood surface, PE matrix, and even maleic anhydride grafted PE. The treated wood fibers were used in the extrusion process to produce sample boards. Liquid trimethoxyvinylsilane (Dynasylan® SIVO 505) was injected to the extruder for reactive extrusion that might create grafting of the silane on the matrix of the PE, resulting in the readiness of the cross-linking reaction. The extrudate from this reactive extrusion was cross-linked after it was processed in a water-cooling spray tank, right after the extrusion or after it is stored in conditioning chamber at high relative humidity (90%) and high temperature (80° C.). It is noted that the mechanical properties increased in WPC samples with silane-treated wood and cross-linked polymer matrix. Dynasylan® CPTEO showed a possibility to replace a maleic anhydride modified polyethylene as a new coupling agent. Dynasylan® 1189 enhanced mechanical properties of chemically coupled WPC. It was shown that Dynasylan® SIVO 505 leads grafting reaction of polymer melt in-situ in extrusion process and the grafted HDPE was cross-linked in the process of water-cooling right after extrusion. Mechanical properties of cross-linked WPC showed 60% increase in strength and 70% increase in modulus.

### Materials

The formulations contain wood fiber, polyethylene matrix, coupling agent, lubricant, and silane grafting-agent. The sample identification is listed in Table 6. The wood fiber utilized in this experiment was 40 mesh pine flour from American Wood Fiber, Wisconsin, USA (#4020BB). The moisture content of the wood fiber in stock ranged 8 to 12%. High density polyethylene (HDPE) was purchased from INEOS Olefins & Polymers, USA. HDPE grade was A4040, high-density polyethylene copolymer, which is used mainly for the extrusion of cross-linked pipes according to the silane process. Grafted high density polyethylene (G-HDPE, 0.7 g/10 min at 190° C./2,160 g) was purchased from Padanaplast, USA Inc. Maleic anhydride grafted polyethylene (MAPE) was used as a coupling agent in the control to compare the effect of silane compounds. N-(n-Butyl)-3-aminopropyltrimethoxysilane (Dynasylan® 1189) was selected to enhance the effect of coupling agent, MAPE. 3-chloropropyltriethoxysilane (Dynasylan® CPTEO) was used to create chemical bridge between wood and HDPE, which is supposed for MAPE to play. Vinyl-/alkylsilane oligomer (Dynasylan® 6598) enhanced the interfacial properties between silane-grafted HDPE and wood fiber. Vinytrimethoxylsilane (Dynasylan® SIVO 505) used in reactive extrusion would graft HDPE with silane branches. Those silane compounds are all liquid type and supplied by Evonik Degussa. All materials are listed in Table 7.

### Treatment of Wood Fiber

The wood fiber was dried in excess of 96 hours in a kiln that operated under 2% relative humidity condition controlled by 150° F. dry bulb and 80° F. wet bulb. The moisture content of wood fiber ranges 1.3 to 1.5% wt. after drying. A portion of the dried wood flour was dried again in an oven at 105° C. for a minimum 24 hours. The totally dried wood flour was prepared for the sample #5, 6, 7, and 8 to prevent any premature cross-linking during the extrusion process. The moisture content was under 1% and within the measurement error of the tester. The drying process according to the sample ID is listed at Table 8.

The dried wood was fed to the spinning disk particle-resin blender system, manufactured by Coil Manufacturing, Canada, that is used to spray resins into powder materials. An atomizer is equipped inside the chamber to spray very small resin particles. The blender ran at 15 RPM and the run time ranged from 10 to 15 minutes, according to the loading level of silane compounds. The loading level was 1% wt. of all silane compounds (1189, 6598, and CPTEO). A small pump was used to inject the silane liquid into the atomizer at speed of 30 g/minute. The pump silane-treated wood fibers were stored in the kiln to keep the moisture content under 2% wt. A part of the wood treated with Dynasylan® 6598 was dried at an oven at 105° C. for 24 hours.

TABLE 6
Sample identification and basic formulations

| | Plastic-side | | | | | |
|---|---|---|---|---|---|---|
| | | Graf-ting | | | Wood-side | |
| Sample # | Matrix | agent | Add. 1 | Add. 2 | (wood fiber) | Note |
| 1 | HDPE | — | — | Lub. | Non-treated | Control |
| 2 | HDPE | — | MAPE | Lub. | Non-treated | Coupled WPC |
| 3 | HDPE | — | MAPE | Lub. | Dynasylan ® | Coupled WPC |
| | | | | | 1189-treated | |
| 4 | HDPE | — | — | Lub. | Dynasylan ® | Coupled WPC |
| | | | | | CPTEO- | |
| | | | | | treated | |
| 5 | HDPE | Dynasylan ® | — | Lub. | Non-treated | Cross-linked |
| | | SIVO 505 | | | | WPC |
| 6 | HDPE | Dynasylan ® | — | Lub. | Dynasylan ® | Cross-linked |
| | | SIVO 505 | | | 6598-treated | WPC |
| 7 | Grafted | — | — | Lub. | Non-treated | Cross-linked |
| | PE | | | | | WPC |
| 8 | Grafted | — | — | Lub. | Dynasylan ® | Cross-linked |
| | PE | | | | 6598-treated | WPC |

TABLE 7
Materials and their proposed functions.

| | Name | Specification | Note |
|---|---|---|---|
| Plastic | HDPE | INEOS A4040 | 4,500 lb, copolymer |
| matrix | | (MFI = 3.5 at 190° C./ | for cross-linking |
| | | 2.16 kg) | |
| | Grafted | Padanaplast PEXIDAN | 1,500 lb |
| | HDPE | L/T (MFI = 0.7 at | Vinyltrimethoxysilane |
| | | 190° C./2.16 kg) | grafted HDPE |
| Wood | Wood flour | Pine, 40 mesh | American Wood Flour, |
| | | | Inc. |
| Ad- | Cross- | Dynasylan ® SIVO | 0.8% dosage on HDPE |
| ditives | linking | 505 | |
| | agent | (Vinyltrimethoxysilane) | |
| | Coupling | Dynasylan ® 1189 | 1% dosage on Wood |
| | agent | (secondary amine) | (Wood-MAPE-1189- |
| | | | HDPE) |
| | Cross- | Dynasylan ® 6598 | 1% dosage on HDPE |
| | linking | (Vinyl-/alkylsilane | |
| | agent | oligomer) | |
| | Dispersion- | Dynasylan ® CPTEO | 1% dosage on HDPE |
| | aid | | |
| | agent | | |
| | Lubricant | Struktol 113 | 5% dosage on total |
| | | | weight |

TABLE 8
Dry process and conditions for each sample ID.

| | | Dried | | Heated | Cross- | Wood | |
|---|---|---|---|---|---|---|---|
| # | Mechanism | (80° C.) | Treated | (150° C.) | linked | Lbs | Note |
| 1 | Control | N | | N | N | — | MC = 8% |
| 2 | Coupled | N | MAPE | N | N | — | MC = 8% |
| 3 | Coupled | Y | Dynasylan ® | N | N | 400 | MC = 1.5% |
| | | | 1189 | | | | |
| 4 | Coupled | Y | CPTEO | N | N | 400 | MC = 1.5% |
| 5 | Cross-linked | Y | | Y | Y | 400 | MC = 0% |
| 6 | Cross-linked | Y | Dynasylan ® | Y | Y | 400 | MC = 0% |
| | | | 6598 | | | | |
| 7 | Cross-linked | Y | | Y | Y | 400 | MC = 0% |
| 8 | Cross-linked | Y | Dynasylan ® | Y | Y | 400 | MC = 0% |
| | | | 6598 | | | | |

2,400 lbs of wood powder needs to be dried at the kiln
800 lbs out of dried wood powder needs to be heated for 5 hours at 105° C.
800 lbs of 6598 treated dried wood powder needs to be heated for 40 min at 150° C.

### Extrusion

The extrusion processing was conducted on a David-Standard® WT-94 Woodtruder™ (AEWC Equipment #156). This particular system consists of a GP94 94 mm counter-rotating parallel twin-screw extruder (28:1 L/D) with a coupled Mark V™ 75 mm single screw extruder. The feed system consists of three Colortronics gravimetric feeders supplying the 75 mm single screw extruder via flood feeding and three (3) Colortronics gravimetric feeders supplying the 94 mm twin-screw extruder via starving feeding. Initially, a control WPC board was produced, which did not have a coupling or cross-linking agent. The run order of samples were the same as the sample number. The sample nomenclature and formulations are listed at Table 9. The extrusion parameters, temperatures, RPM of screws, and output rate, etc. are shown at Table 10 for each sample production. The output rate of extrusion was set to 200 lbs/hour and the feeding system automatically set the amount of materials according to the formulations. The line speed of the extrudate was about 2.3 feet/minute, which changed very little between each sample type so it can be ignored. In each sample production, the screw RPM was reset for the constant output rate. The extruder torque was recorded, in percent, for each formulation, which would be closely related with polymer melt rheology.

### Injection of Silane Cross-Linking Agent

In the production of Sample #5 and #6, the silane compound was injected into the HDPE feeder. The silane compounds were supposed to initiate grafting reaction in the HDPE which would lead a cross-linking of the grafted polymer chains during water-aided curing process. A plastic tube was connected between the polymer feeder of the extrusion system and 1,000 ml flask with Dynasylan® SIVO 505 silane compound. A pump (Masterflex® US Easy-Load) delivered the silane compound to the polymer feeder at a constant rate. The rate was controlled by the speed of the pump head. The weight percentage of the silane compound was 0.8% to the total weight of the extrudate.

TABLE 9
The nomenclature and formulations of samples

| Sample # | Mechanism | HDPE | WOOD | LUB. | CA | Cross-link |
|---|---|---|---|---|---|---|
| 1 | Control | Ineos 45% | NT 50% | 5% | — | — |
| 2 | Coupled | Ineos 45% | NT 50% | 5% | MAPE 2% | — |
| 3 | Coupled | Ineos 45% | T 50% | 5% | MAPE 2% | — |
| | | | | | Dynasylan ® | |
| | | | | | 1184 Treat | |
| 4 | Coupled | Ineos 45% | T 50% | 5% | Dynasylan ® | — |
| | | | | | CPTEO Treat | |
| 5 | Cross-linked | Ineos 45% | NT 50% | 5% | — | Dynasylan ® |
| | | | | | | SIVO 505 |
| | | | | | | 0.8% |
| 5 H₂O* | Cross-linked | Ineos 45% | NT 50% | 5% | — | Dynasylan ® |
| | | | | | | SIVO 505 |
| | | | | | | 0.8% |
| 6 | Cross-linked | Ineos 45% | T 50% | 5% | Dynasylan ® | Dynasylan ® |
| | Dynasylan ® | | | | 6598 Treated | SIVO 505 |
| | 6598 grafted | | | | | 0.8% |
| 6 H₂O* | Cross-linked | Ineos 45% | T 50% | 5% | Dynasylan ® | Dynasylan ® |
| | | | | | 6598 Treated | SIVO 505 |
| | | | | | | 0.8% |
| Dynasylan ® | Coupled | Ineos 45% | T 50% | 5% | Dynasylan ® | — |
| 6598 | | | | | 6598 Treated | |
| 7 | Cross-linked | Pexidan | NT 50% | 5% | — | CAT 009 1.8% |
| 8 | Cross-linked | Pexidan | T 50% | 5% | Dynasylan ® | CAT 009 1.8% |
| | | | | | 6598 Treated | |

*H₂O means that the sample boards were conditioned at 90% relative humidity and 80° C.

The conditioned sample will be named as post-cured sample.

The non-conditioned samples will be named as site-cured sample, which means the samples are cured at the site of the cooling line of the extrusion.

TABLE 10
The processing parameters of extrusion for each sample
Sample #1

| T72 | Z1 | Z2 | Z3 | Z4 | Z5 | Clamp | Adaptor | Melt T. |
|---|---|---|---|---|---|---|---|---|
| Single | 140 | 150 | 180 | 200 | 180 | 200 | 200 | 175 |
| T95 | Z1 | Z2 | Z3 | Z4 | Z5 | Z6 | Z7 | Z8 |
| Twin | 170 | 170 | 170 | 170 | 160 | 150 | 145 | 145 |

| | | | | | | | |
|---|---|---|---|---|---|---|---|
| Die Tooling | Adaptor | D1 | D2 | D3 | D4 | Pressure | Pressure |
| | | | | | | (T72) | (T95) |
| | 180 | 160 | 175 | 160 | 155 | 780 psi | 545 psi |

| | | | | | | |
|---|---|---|---|---|---|---|
| Screw | T72 | T95 | Extruder | T72 | T95 | Output Rate |
| RPM | 21 | 20 | Torque | 40% | 26% | 200 lbs/hr |

Sample #2

| | | | | | | | | |
|---|---|---|---|---|---|---|---|---|
| T72 | Z1 | Z2 | Z3 | Z4 | Z5 | Clamp | Adaptor | Melt T. |
| Single | 140 | 150 | 180 | 200 | 180 | 200 | 200 | 175 |
| T95 | Z1 | Z2 | Z3 | Z4 | Z5 | Z6 | Z7 | Z8 |
| Twin | 170 | 170 | 170 | 170 | 160 | 150 | 145 | 145 |

| | | | | | | | |
|---|---|---|---|---|---|---|---|
| Die Tooling | Adaptor | D1 | D2 | D3 | D4 | Pressure | Pressure |
| | | | | | | (T72) | (T95) |
| | 180 | 160 | 175 | 160 | 155 | 750 psi | 525 psi |

| | | | | | | |
|---|---|---|---|---|---|---|
| Screw | T72 | T95 | Extruder | T72 | T95 | Output Rate |
| RPM | 20 | 19 | Torque | 40% | 27% | 200 lbs/hr |

Sample #3

| | | | | | | | | |
|---|---|---|---|---|---|---|---|---|
| T72 | Z1 | Z2 | Z3 | Z4 | Z5 | Clamp | Adaptor | Melt T. |
| Single | 140 | 150 | 180 | 200 | 180 | 200 | 200 | 175 |
| T95 | Z1 | Z2 | Z3 | Z4 | Z5 | Z6 | Z7 | Z8 |
| Twin | 170 | 170 | 170 | 170 | 160 | 150 | 145 | 145 |

| | | | | | | | |
|---|---|---|---|---|---|---|---|
| Die Tooling | Adaptor | D1 | D2 | D3 | D4 | Pressure | Pressure |
| | | | | | | (T72) | (T95) |
| | 180 | 160 | 175 | 160 | 155 | 750 psi | 525 psi |

| | | | | | | |
|---|---|---|---|---|---|---|
| Screw | T72 | T95 | Extruder | T72 | T95 | Output Rate |
| RPM | 20 | 20 | Torque | 40% | 27% | 200 lbs/hr |

Sample #4

| | | | | | | | | |
|---|---|---|---|---|---|---|---|---|
| T72 | Z1 | Z2 | Z3 | Z4 | Z5 | Clamp | Adaptor | Melt T. |
| Single | 140 | 150 | 180 | 200 | 180 | 200 | 200 | 175 |
| T95 | Z1 | Z2 | Z3 | Z4 | Z5 | Z6 | Z7 | Z8 |
| Twin | 170 | 170 | 170 | 170 | 160 | 150 | 145 | 145 |

| | | | | | | | |
|---|---|---|---|---|---|---|---|
| Die Tooling | Adaptor | D1 | D2 | D3 | D4 | Pressure | Pressure |
| | | | | | | (T72) | (T95) |
| | 180 | 160 | 175 | 160 | 155 | 495 psi | 615 psi |

| | | | | | | |
|---|---|---|---|---|---|---|
| Screw | T72 | T95 | Extruder | T72 | T95 | Output Rate |
| RPM | 20 | 20 | Torque | 40% | 27% | 200 lbs/hr |

Sample #5

| | | | | | | | | |
|---|---|---|---|---|---|---|---|---|
| T72 | Z1 | Z2 | Z3 | Z4 | Z5 | Clamp | Adaptor | Melt T. |
| Single | 140 | 150 | 180 | 200 | 180 | 200 | 200 | 175 |
| T95 | Z1 | Z2 | Z3 | Z4 | Z5 | Z6 | Z7 | Z8 |
| Twin | 170 | 170 | 170 | 170 | 160 | 150 | 145 | 145 |

| | | | | | | | |
|---|---|---|---|---|---|---|---|
| Die Tooling | Adaptor | D1 | D2 | D3 | D4 | Pressure | Pressure |
| | | | | | | (T72) | (T95) |
| | 180 | 160 | 175 | 160 | 155 | 800 psi | 650 psi |

| | | | | | | |
|---|---|---|---|---|---|---|
| Screw | T72 | T95 | Extruder | T72 | T95 | Output Rate |
| RPM | 21 | 20 | Torque | 49% | 27% | 200 lbs/hr |

Sample #6

| | | | | | | | | |
|---|---|---|---|---|---|---|---|---|
| T72 | Z1 | Z2 | Z3 | Z4 | Z5 | Clamp | Adaptor | Melt T. |
| Single | 140 | 150 | 180 | 200 | 180 | 200 | 200 | 175 |
| T95 | Z1 | Z2 | Z3 | Z4 | Z5 | Z6 | Z7 | Z8 |
| Twin | 170 | 170 | 170 | 170 | 160 | 150 | 145 | 145 |

| | | | | | | | |
|---|---|---|---|---|---|---|---|
| Die Tooling | Adaptor | D1 | D2 | D3 | D4 | Pressure | Pressure |
| | | | | | | (T72) | (T95) |
| | 180 | 160 | 175 | 160 | 155 | 750 psi | 650 psi |

| | | | | | | |
|---|---|---|---|---|---|---|
| Screw | T72 | T95 | Extruder | T72 | T95 | Output Rate |
| RPM | 22 | 20 | Torque | 43% | 27% | 200 lbs/hr |

Sample #7

| | | | | | | | | |
|---|---|---|---|---|---|---|---|---|
| T72 | Z1 | Z2 | Z3 | Z4 | Z5 | Clamp | Adaptor | Melt T. |
| Single | 140 | 155 | 180 | 180 | 180 | 200 | 200 | 175 |
| T95 | Z1 | Z2 | Z3 | Z4 | Z5 | Z6 | Z7 | Z8 |
| Twin | 170 | 170 | 170 | 170 | 165 | 160 | 160 | 150 |

| | | | | | | | |
|---|---|---|---|---|---|---|---|
| Die Tooling | Adaptor | D1 | D2 | D3 | D4 | Pressure | Pressure |
| | | | | | | (T72) | (T95) |
| | 180 | 160 | 175 | 160 | 155 | 750 psi | — psi |

| | | | | | | |
|---|---|---|---|---|---|---|
| Screw | T72 | T95 | Extruder | T72 | T95 | Output Rate |
| RPM | 20 | 20 | Torque | 42% | — % | 200 lbs/hr |

### Tests for the Physical and Mechanical Properties

### Flexural Bending

The formulations were subjected to 4 point flexural bending in accordance with ASTM D 6109. Five (5) replicates for each formulation were tested using a 22-kip Instron universal testing machine on a 4-point flexure fixture. The MOR and MOE were the calculated mechanical properties reported from the results.

### Tensile

Each formulation was subjected to tensile testing in accordance with ASTM D 638. Dog bones were manufactured using a router jig, such that the narrow section of the dog bone has a nominal width of ¾″ and a nominal thickness of less then ½″ (Type III specimen in D 638). A total of five (5) replicates for each formulation will be tested at the AEWC using a 22-kip Instron universal testing machine. The specimens were tested under a loading rate of 0.2 inch/min, and an extensometer recorded the axial strain on the specimen. The mechanical property reported from each formulation will be the ultimate tensile strength (UTS) of the material and the tensile modulus of elasticity (TMOE).

### Impact

The specimens from each formulation were tested in accordance with ASTM D 256. A total of five (5) replicates were tested on a Resil 50B pendulum impact tester with a 2.75 J Izod hammer. The notch were cut to ASTM D 256 specifications using a Ceast Notchvis notch cutter. The mechanical property reported is the impact resistance.

### Thermal Expansion

The specimens from each formulation were tested in accordance with ASTM D 696. A total of five (5) replicates were tested using a vitreous submerged into a temperature controlled bath. Specimens were cut from both the transverse axis of the material (opposite axis of extrusion) and the machine axis of the material (along the axis of extrusion). This is due to the anisotropic CTE values seen in extruded thermoplastics. Each specimen was exposed to a steady-state temperature of −30° C. and 30° C., with the change in length recorded for analysis. This change in length was used to calculate the coefficient of thermal expansion (based on the change in length per degree temperature change).

### Gel Content Test

The gel content of the samples were determined using p-xylene extraction, according to ASTM D2765. Approximately 0.3 g of the ground sample (about 80 mesh size) was placed in the weighed metal pouch made of fine stainless wire (150 mesh size). A round-bottom flask was filled by 350 g of p-xylene to immerse the 150-mesh cage in a 500-mL flask. An antioxidant was resolved with p-xylene to inhibit any further cross-linking of the specimen.

### Extrusion Process

Deck boards of sample #1, 2, 3, 4, 5, and 6 were produced. On the whole, the processing parameters of extrusion were similar with general PE-WPC production except for sample #7. The melt pressure of the samples was appropriate and melt temperatures were very stable. An increase (about 20%) of melt pressure was noted in the sample #5 and #6 since those sample formulations included a silane compound that creates a grafting reaction during the process.

The wood contents of the extrudate from sample #7 was reduced to prevent dramatic melt pressure increase, since it was supposed that the grafted HDPE would react with the tiny water content of wood fibers. Wood fibers must have some water content even though they are fully dried, since wood fiber absorbs anytime during transportation or even in the feeder. Moreover, wood basically has lots of hydroxyl groups that play a similar role with moisture when they meet grafted HDPE. So, the wood content was reduced from 50% wt. to 33% wt. to make the potential reaction mild. The twin screw extruder showed a high value of melt pressure, up to 1,400 psi, which normally ranged from 500 psi to 600 psi. The extrudate (#1) was so dry and fragile it did not flow well inside the die.

To increase the flowability of the melt, the polymer content was increased by decreasing the wood content from 33% wt. to 20% wt. The melt pressure of twin screw extruder was decreased right after the change from 1,400 psi to 1,100˜1,200 psi. The dryness of the extrudate (#2) was improved but it was still hard to form the shape of the extrudate.

Again, the wood content was reduced to 16% wt to increase the wetness of melts but it did not make a big difference in the sample extrudate (#3).

At this time, a vacuum was applied to the twin screw extruder to remove any potential gaseous materials from the extruder. Gas is a very common byproduct of chemical reactions. The extrudate (#4) looked a little better with smooth surfaces and more density.

The wood content was once more reduced from 16% wt. to 10% wt but the extrudate (#5) did not show a significant difference in appearance. As these trials were performed, the solidified melts accumulated inside the die and increased the melt pressure and die pressure. The die temperatures were increased but failed to get rid of the accumulated solidified melts. The extrusion was stopped before the high limit of a melt pressure created safety issues.

### Mechanical Properties

### Flexural Properties

The results of the flexural properties are shown in Table 11. It was found that the silane treated wood fiber showed higher strength and modulus than the control composite. The sample #2 with conventional coupling agent (maleic anhydride modified high density polyethylene) was stronger than the control sample. The chemically coupled interfaces between wood fiber and HDPE matrix improved the strength and modulus.

The composite sample of wood fiber treated with D1189 silane compound showed no improvement in flexural strength but did in flexural modulus.

The sample #4 showed that there was a decrease in both strength and modulus compared to the sample #3. The sample #4 was formulated with D CPTEO, which would be used instead MAPP for chemical coupling agent. The effect of chemical coupling from D CPTEO was not enough to replace MAPP.

The sample #5, #5 H₂O, #6, and #6 H₂O showed a big improvement in both strength and modulus. They were the cross-linked composites which were generated in-situ reactive extrusion. It was seen that the cross-linked composites are stronger than control and chemically coupled composites. There was no significant differences between cross-linked composites (post-cured samples and site-cured samples), even if the post-cured samples were conditioned at high temperature (80 [symbol] )/high relative humidity (90%) to enhance the mechanism of cross-linking.

The samples #6 and #6 H₂O were formulated with SIVO and D6598 that was supposed to improve the interface between wood fiber and silane-grafted HDPE while the sample #5 and #5 H₂O does have only SIVO for grafting and cross-linking. There, however, was no significant difference between sample #5 and #6. It implies that D6598 did not enhance the interfacial properties of silane-grafted HDPE and wood.

It is noted that the sample #6598 showed high strength and modulus compared to the control and chemically coupled composites. The sample #6598 is the composite with D6598 treated wood fiber and HDPE. D6598 is supposed to work for the interface between silane-grafted/cross-linked HDPE and wood fiber. There is no improvement from the D6598 in cross-linked composite but there was a significant improvement in the composite with treated wood and HDPE in non-cross-linked samples. The increase of strength and modulus is very comparable with other chemically coupled sample composite (sample #2, #3, and #4). The production of the sample #6598 was not planned at the beginning of this project.

TABLE 11
Flexural properties of the samples

| | Sample # | | | | | | | | |
|---|---|---|---|---|---|---|---|---|---|
| | D1 | D2 | D3 | D4 | D5 | D5 H₂O | D6 | D6 H₂O | D6598 |
| Flex. Strength | 2,782 | 3,806 | 3,638 | 2,901 | 4,256 | 4,245 | 4,290 | 4,160 | 3,516 |
| (lbs/in²) | 3.88%* | 23.03% | 1.36% | 3.15% | 3.65% | 4.71% | 2.47% | 3.50% | 17.48% |
| Flex. Modulus | 273,174 | 328,996 | 416,003 | 362,809 | 466,342 | 471,995 | 433,825 | 440,091 | 435,096 |
| (lbs/in²) | 9.91% | 19.47% | 7.30% | 9.05% | 7.28% | 12.29% | 13.73% | 5.96% | 11.48% |

*COV: Coefficient of variation, the ratio of the standard deviation to the mean

### Tensile Properties

The result of tensile test is shown at Table 12. The trends of changes in tensile properties by samples were similar with flexural properties. It, however, is less clear that cross-linked composites show better tensile properties than chemically coupled composites. All composites with silane compounds, however, showed 12% to 68% and 27% to 92% increases each in strength and modulus.

TABLE 12
Tensile properties of the samples

| | Sample # | | | | | | | | |
|---|---|---|---|---|---|---|---|---|---|
| | D1 | D2 | D3 | D4 | D5 | D5 H₂O | D6 | D6 H₂O | D6598 |
| Tensile | 1,321 | 1,876 | 2,107 | 1,474 | 2,116 | 1,974 | 2,029 | 2,223 | 1,802 |
| Strength | 5.31%* | 5.85% | 5.96% | 5.38% | 22.57% | 7.90% | 9.95% | 5.83% | 26.28% |
| (lbs/in²) | | | | | | | | | |
| Tensile | 1,698,646 | 2,602,135 | 3,105,293 | 2,164,307 | 2,709,354 | 2,867,774 | 2,723,088 | 3,266,348 | 2,694,119 |
| Modulus | 13.50% | 9.60% | 11.05% | 17.64% | 18.37% | 7.63% | 15.77% | 6.97% | 20.83% |
| (lbs/in²) | | | | | | | | | |

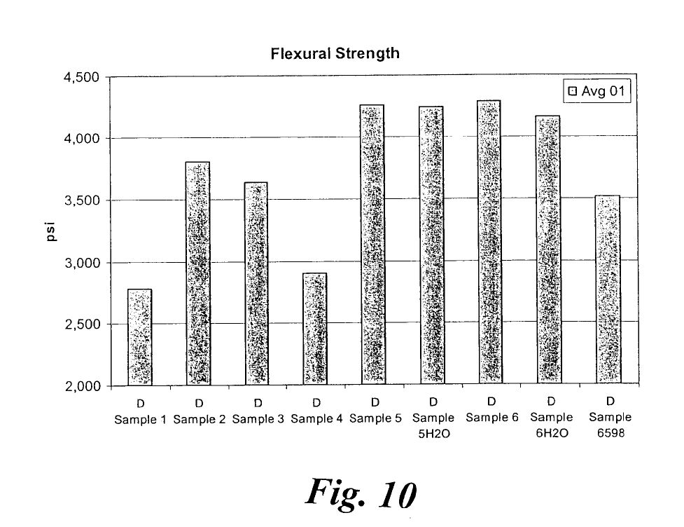

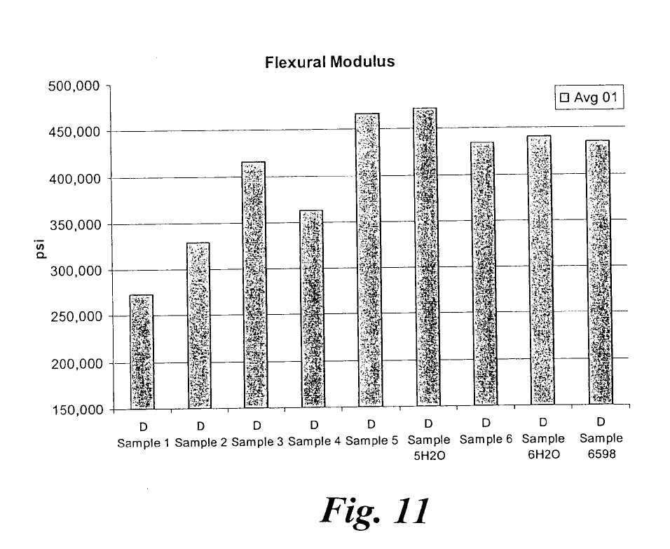

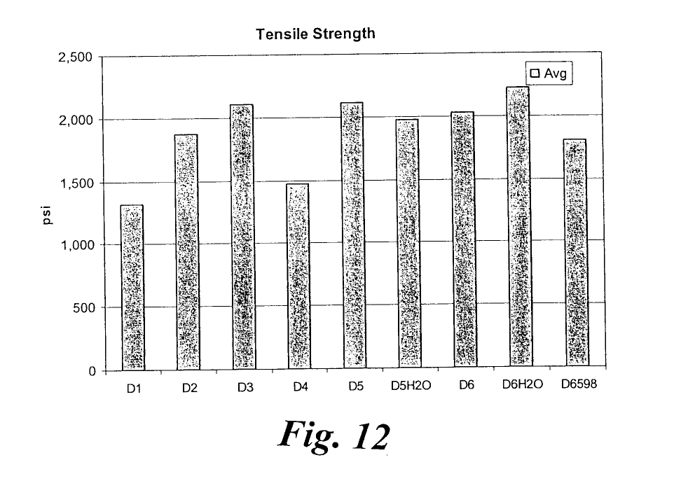

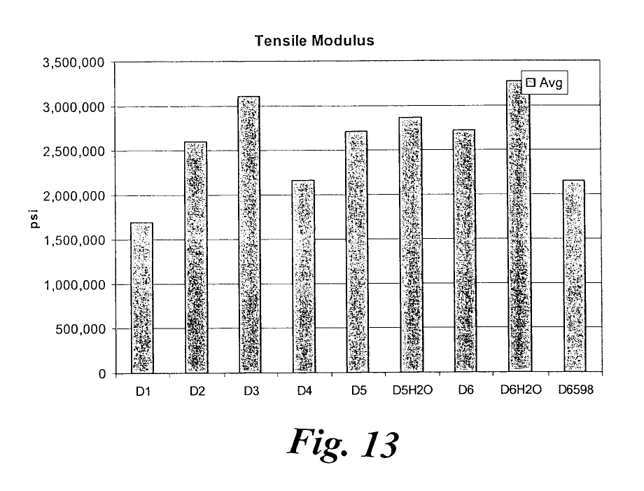

*COV: Coefficient of variation, the ratio of the standard deviation to the mean.
See also FIGS. 10-13 for the results for flexural strength, flexural modulus, tensile strength and tensile modulus.

### Impact Properties

Impact strength and coefficient of thermal expansion of the samples are listed at Table 13. It is not clear that silane coupling agents (#D3 and #D4) affect the impact strength of the treated samples but silane-induced cross-linked WPC showed a small increase in strength. According to the experiments by Magnus Bengtsson and Kristiina Oksman (Department of Engineering Design and Materials, Norwegian University of Science and Technology), the clearest evidence of cross-linking was an improvement of impact strength that is closely related to the propagation of crack through the polymer chains. In this study, however, the impact strength was relatively low because of 50% wt. wood fillers. It is very well known that impact strength dramatically decreases with addition of wood filler to polyethylene. In the previous study of cross-linked WPC, the wood loading level was only 40% wt. compared to 50% wt. of wood loading level in this study.

TABLE 13
Impact strength and coefficient of thermal expansion of the samples

| | Sample # | | | | | | | | |
|---|---|---|---|---|---|---|---|---|---|
| | D1 | D2 | D3 | D4 | D5 | D5 H₂O | D6 | D6 H₂O | D6598 |
| Impact | 37.04 | 34.71 | 34.43 | 38.10 | 43.06 | 48.36 | 38.14 | 38.64 | 37.05 |
| Strength | 2.07%* | 1.74% | 6.50% | 5.42% | 6.79% | 12.05% | 3.52% | 4.71% | 2.12% |
| (J/m) | | | | | | | | | |
| CTE | 4.798 | 4.050 | 4.394 | 4.228 | 5.821 | 5.865 | 4.735 | 5.041 | 4.087 |
| (10⁻⁵) | 8.89% | 5.44% | 8.80% | 19.73% | 12.42% | 24.74% | 19.56% | 40.89% | 26.04% |

*COV: Coefficient of variation, the ratio of the standard deviation to the mean.

### Coefficient of Thermal Expansion

In the results of CTE, the cross-linked WPC showed a relatively high value of CTE. CTE of WPC showed relatively very low value compared to the one (77.8×10⁻⁶ in/in ° F.) of general HDPE products.

### Gel Contents

In the gel content test, it should be noted before any analysis, that some components of wood can be extracted during the test, which may result in lower value of the degree of cross-linking since the extractives from the wood would be assumed as a loss of non-crosslinked polymer matrix. The extractives of wood by p-xylene will be studied to correct the exact gel content. It may be assumed that the degree of cross-linking would be underestimated.

Table 14 shows the degree of cross-linking from the gel content tests. It is noted that the degree of cross-linking is relatively low if it is compared to the general cross-linked HDPE in electric wire applications. Magnus Bengtsson and Kristiina Oksman (Department of Engineering Design and Materials, Norwegian University of Science and Technology) reported that they produced cross-linked WPC which had the degree of cross-linking ranged from 36% to 74%. The addition of silane solutions was up to 6% wt. In this study, the silane solution (Dynasylan® SIVO 505) was added only 0.8% wt. to the composite, which is relatively very mild condition compared to the study done by Oksman.

The improvement in mechanical properties happens at tensile modulus and impact strength of the samples in terms of efficiency of cross-linking. Oksman noticed that the clear improvement according to the different degree of cross-linking was found in the creep properties which might be closely related with a elastic modulus. It was reported that the gel content, with an increased addition of silane solution, was increased in the composites stored at room temperature. This shows that a higher level of silane addition during processing, increasing the cross-linking that took place during processing. This may explain why the degree of cross-linking was relatively small in this study.

The post-cure sample, which was conditioned at high relative humidity and temperature, showed high degree of cross-linking, up to twice those of site-cured samples, with no further conditioning after the downstream process of extrusion.

TABLE 14
The degree of cross-linking of the samples from gel content test

| | Sample # | | | | | | | | |
|---|---|---|---|---|---|---|---|---|---|
| | | | | | | | | | Dynasylan ® |
| | D1 | D2 | D3 | D4 | D5 | D5 H₂O | D6 | D6 H₂O | 6598 |
| Degree of | — | — | — | — | 20.51% | 46.75% | 14.57% | 30.22% | — |
| Cross-linking | | | | | | | | | |

Silane coupling agents were added to the wood plastic composites to evaluate the effect compared to the conventional coupling agents (MAPP). The WPC's with silane coupling agents improved in flexural and tensile properties. The improvement is superior to the one from a conventional coupling agent of MAPP in flexural modulus, tensile strength and tensile modulus. Especially, the D 1189 played a significant role to boost the interaction with MAPP grafted HDPE and wood.

Silane cross-linked WPC's were produced in the in-situ reactive extrusion process. An addition of silane solution during the process increased the melt viscosity significantly, as a result of both premature cross-linking and interaction between grafted silane groups. The degree of cross-linking ranges from 20% to 50%, which are relatively low because of the high wood loading level. The cross-linked WPC's significantly improved the mechanical properties up to a 70% increase. There was no clear difference in mechanical properties between post-cured composites and site-cured composite even though the degree of cross-linking shows different values.

Numerous modifications and variations on the present invention are possible in light of the above teachings. It is therefore to be understood that within the scope of the appended claims, the invention may be practiced otherwise than as specifically described herein.

1. A method of producing a composite of a lignocellulosic material and a plastic, comprising:
grafting an organosilane to said plastic, to obtain a grafted plastic; and
compounding said grafted plastic with said lignocellulosic material, to obtain said composite.

2. The method of claim 1, wherein said plastic comprises a thermoplastic resin.

3. The method of claim 1, wherein said lignocellulosic material comprises wood.

4. The method of claim 3, wherein said wood is in the form of at least one member selected from the group consisting of wood fiber, wood turnings, wood chips, and wood flour.

5. The method of claim 1, further comprising:
adding an additive.

6. The method of claim 1, wherein said plastic comprises a polyolefin.

7. The method of claim 1, wherein said organosilane is at least one member selected from the group consisting of a vinylsilane, a vinylsilane oligomer, an aminosilane, an aminoalkylsilane, an N-alkylaminoalkylsilane an alkylsilane, an alkylsilane oligomer, a vinyl-/alkylsilane oligomer, an aminoalkylsilane oligomer, a fluorosilane, a fluoroalkylsilane, and a polyglycol functional silane.

8. The method of claim 1, wherein, in said grafting step, a vinylsilane is combined with a peroxide or a peroxide and a catalyst.

9. The method of claim 1, comprising reactive extrusion of a polymer with vinylsilane and a wood flour in one extruder.

10. (canceled)

11. The method of claim 1, wherein said thermoplastic resin and said lignocellulosic material are recycled.

12. The method of claim 1, wherein said lignocellulosic material comprises a filler.

13. The method of claim 1, wherein said filler is present in an amount of 10 to 95% by weight, based on the weight of the composite.

14. The method of claim 1, wherein said filler has a moisture content of 0.1 to 10% by weight, based on the weight of the filler.

15. The method of claim 1, wherein said organosilane comprises at least one vinylsilane selected from the group consisting of vinyltrimethoxysilane, vinyltriethoxysilane, vinyltrimethoxyethoxysilane, and vinyltripropoxysilane.

16. The method of claim 1, wherein said organosilane comprises at least one vinyl oligomer selected from the group consisting of a vinylmethoxysilane oligomer, a vinylethoxysilane oligomer, a vinyl-/n-propylmethoxysilane cooligomer, a vinyl-/propylethoxysilane cooligomer, a vinyl-/butylmethoxysilane cooligomer, a vinyl-/octylmethoxysilane cooligomer, a vinyl-/butylethoxysilane cooligomer, and a vinyl-/octylethoxysilane cooligomer.

17. The method of claim 1, wherein said organosilane comprises at least one aminosilane selected from the group consisting of an aminopropyltrimethoxysilane, an aminopropyltriethoxysilane, an aminoethylaminopropyltrimethoxysilane, and an aminoethylaminoethylaminopropyltrimethoxysilane.

18. The method of claim 1, wherein said organosilane comprises at least one alkylsilane of formula (I)
R¹Si(OR′)₃ (I),
wherein R¹ is a linear, cyclic, or branched alkyl rest with 1-20 C-atoms.

19. The method of claim 1, wherein said organosilane comprises at least one alkylsilane selected from the group consisting of n-propyltrimethoxysilane (PTMO), n-propyltriethoxysilane (PTEO), i-butyltrimethoxysilane (IBTMO), i-butyltriethoxysilane (IBTEO), octyltrimethoxysilane (OCTMO), octyltriethoxysilane (OCTEO), 3-chloropropyltrimethoxysilane (CPTMO), and 3-chloropropyltriethoxysilane (CPTEO).

20. The method of claim 1, wherein said compounding is for a period of time from 1 min. to 10 hours.

21. The method of claim 1, wherein said compounding is at a reaction temperature of 40 to 80° C.
